(19) United States
(12) Patent Application Publication
(10) Pub. No.: US 2011/0154120 A1
(43) Pub. Date: Jun. 23, 2011

(54) APPARATUS AND SYSTEM FOR INTEGRATEDLY MANAGING STATIC ANALYSIS TOOLS

(75) Inventors: Tae Ho Kim, Gunpo (KR); Ik Soon Kim, Daejeon (KR); Chae Deok Lim, Daejeon (KR); Dong Sun Lim, Daejeon (KR)

(73) Assignee: ELECTRONICS AND TELECOMMUNICATIONS RESEARCH INSTITUTE, Daejeon (KR)

(21) Appl. No.: 12/969,736

(22) Filed: Dec. 16, 2010

(30) Foreign Application Priority Data
Dec. 18, 2009 (KR) 10-2009-0127490
Jun. 17, 2010 (KR) 10-2010-0057732

(51) Int. Cl. G06F 11/27

(52) U.S. Cl. 714/37; 714/E11.169

(57) ABSTRACT

An apparatus for integratedly managing static analysis tools includes: a tool configuration module receiving initial configuration information in an integrated configuration format for an analysis of static analysis tools from a user, converting the initial configuration information in the integrated configuration format into initial configuration information in an initial configuration format of the static analysis tools, and transmitting the same; a result output module receiving analysis results from the static analysis tools, converting the received analysis results into a common analysis result format, and outputting the same; an analysis configuration module receiving analysis configuration information from the user, converting the received analysis configuration information into analysis configuration information in an analysis configuration format of the static analysis tools, and transmitting the same; and an execution management module performing one or more of functions such as management of the analysis performing of the static analysis tools, management of the configuration of the static analysis tools themselves, and management of the verification rules of the static analysis tools.

### CROSS-REFERENCE TO RELATED APPLICATIONS

This application claims the priority of Korean Patent Application No. 10-2009-0127490 filed on Dec. 18, 2009, and 10-2010-0057732 filed on Jun. 17, 2010, in the Korean Intellectual Property Office, the disclosure of which is incorporated herein by reference.

### BACKGROUND OF THE INVENTION

1. Field of the Invention

The present invention relates to an apparatus and system for integratedly managing static analysis tools, and more particularly, to an apparatus and system for integratedly managing a plurality of program static analysis tools in an environment in which the plurality of program static analysis tools are in use.

2. Description of the Related Art

A static analysis tool refers to an analysis tool employing a scheme of detecting an error in a program through a mathematical proofing method, a method of performing symbols, and the like, rather than actually executing the program. Because the static analysis tool does not require that the program be run in actuality, it does not need a program execution environment to be set, and in addition, because the static analysis tool can be used to detect a program error, even with the development of a program uncompleted, it has recently been widely utilized in the development of numerous programs.

In general, a program static analysis tool includes a module for configuring a static analysis tool, a module for outputting analysis results, and a module for configuring user analysis results over the analysis results.

The module for configuring a static analysis tool enables a developer to select a target program and select a verification rule for the verification target.

The module for outputting the analysis results from the static analysis tool provides analysis information to a user, obtained by analyzing the program. The program analysis results may include, for example, the kind of error that has occurred, information concerning the generated error, how significant the generated error is, whether or not there is a possibility that the error extracted according to the analysis results is not an actual error, information regarding what has basically caused the error, or path information with regard to the error.

The module for configuring the user's analysis results over the static analysis results receives a user's review as to whether or not the error information has been confirmed, whether or not the analysis results are accurate, and the like. Through this operation, an error which does not occur in actuality can be distinguished and a user's intentional expression is represented. By doing this, the possibility of repeated analysis afterwards can be eliminated.

Various commercial and open static analysis tools have recently been developed. However, the difference in the basic philosophy of analysis tools, such as the development purpose thereof, the type of error to be verified thereby, the verification method thereof, the degree of abstraction therein, an analysis tool implementation technique or empirical heuristic technique, an analysis rate, and the like, brings about a difference in the types of errors detected by the respective static analysis tools and the accuracy of error detection. Thus, it is not possible to directly compare respective static analysis tools in order to distinguish their superiority.

Therefore, in order to comprehensively analyze a program, the use of a plurality of static analysis tools, rather than the use a single static analysis tool, would be preferable, in terms of complementation (or supplementation).

However, the existing method of using a plurality of static analysis tools includes a setting step, a step of outputting analysis results, and a step of configuring a user's analysis results over the analysis results, which are performed on the respective static analysis tools, causing a problem in that some operations are repeatedly performed.

FIG. 1 illustrates an example of the related art static analysis tool management system using a plurality of static analysis tools.

With reference to FIG. 1, a user who uses the static analysis tools A, B, and C must individually perform a setting operation, an outputting operation, and an operation of configuring a user analysis with respect to each of the static analysis tools A, B, and C. The operation of selecting a verification target program or the like is performed in the same manner for each tool. In addition, the operation of configuring a user analysis on the same error information must be configured for each of the static analysis tools which have outputted error information, resulting in a situation in which the operations are repeatedly performed.

Moreover, it is not easy for the user to learn the usage of a wide range of static analysis tools, which involves the possibility that the user may make a mistake in configuring the respective tools.

Another problem of the related art static analysis tool management system using a plurality of static analysis tools is that it is very difficult to determine the order of priority in correcting the errors discovered by the plurality of static analysis tools. Of course, the order of priority for correction may be determined over errors discovered by the individual static analysis tools; however, the order of priority in this case is merely the individual order of priority with respect to each of the static analysis tools. Namely, it remains difficult for the related art to integrate the results from various static analysis tools to determine the overall order of priority for addressing program errors detected thereby.

### SUMMARY OF THE INVENTION

An aspect of the present invention provides an apparatus and system for integratedly managing static analysis tools capable of integratedly (or collectively) managing a process of configuring a plurality of static analysis tools, a process of outputting analysis results from the static analysis tools, and a process of configuring user analysis based on the analysis results in an environment in which the plurality of static analysis tools are in use.

According to an aspect of the present invention, there is provided an apparatus for integratedly managing static analysis tools, including: a tool configuration (or setup) module receiving initial configuration information in an integrated configuration format for an analysis of static analysis tools from a user, converting the initial configuration information in the integrated configuration format into initial configuration information in an initial configuration format of the static analysis tools, and transmitting the same; a result output module receiving analysis results from the static analysis tools, converting the received analysis results into a common analysis result format, and outputting the same; an analysis configuration module receiving analysis configuration information from the user, converting the received analysis configuration information into analysis configuration information in an analysis configuration format of the static analysis tools, and transmitting the same; and an execution management module performing one or more of functions such as management of the analysis performing of the static analysis tools, management of the configuration of the static analysis tools themselves, and management of the verification rules of the static analysis tools.

According to another aspect of the present invention, there is provided a system for integratedly managing static analysis tools, including: a plurality of static analysis tools statically analyzing an analysis target program; and an apparatus integratedly managing static analysis tools and including a tool configuration module receiving initial configuration information in an integrated configuration format for an analysis of static analysis tools from a user, converting the initial configuration information in the integrated configuration format into initial configuration information in the initial configuration format of the static analysis tools, and transmitting the same, a result output module receiving analysis results from the static analysis tools, converting the received analysis results into a common analysis result format, and outputting the same, an analysis configuration module receiving analysis configuration information from the user, converting the received analysis configuration information into analysis configuration information in an analysis configuration format of the static analysis tools, and transmitting the same, and an execution management module performing one or more of functions such as management of the analysis performing of the static analysis tools, management of the configuration of the static analysis tools themselves, and management of the verification rules of the static analysis tools.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic block diagram showing an example of using a plurality of static analysis tools according to the related art;

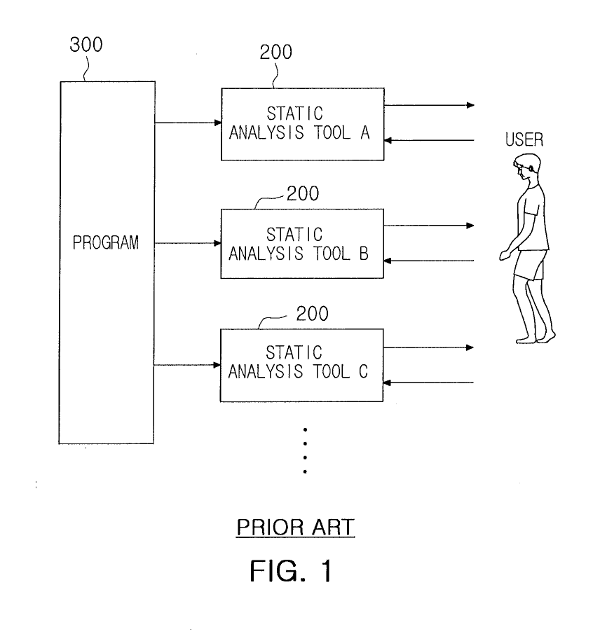

FIG. 2 is a schematic block diagram of a system for integratedly managing static analysis tools using an apparatus for integratedly managing static analysis tools according to an exemplary embodiment of the present invention;

FIG. 3 is a schematic block diagram of a system for integratedly managing static analysis tools using an apparatus for integratedly managing static analysis tools according to another exemplary embodiment of the present invention;

FIG. 4 is a schematic function block diagram showing function blocks of the apparatus for integratedly managing static analysis tools according to an exemplary embodiment of the present invention;

FIG. 5 is a schematic function block diagram showing function blocks of a tool configuration module of the apparatus for integratedly managing static analysis tools according to an exemplary embodiment of the present invention;

FIG. 6 is a view illustrating a screen image of integratedly setting static analysis tools provided by a configuration interface of the apparatus for integratedly managing static analysis tools according to an exemplary embodiment of the present invention to a user;

FIG. 7 is a view illustrating an example of a file stored in a common configuration format by the configuration interface of the apparatus for integratedly managing static analysis tools according to an exemplary embodiment of the present invention;

FIG. 8 is a schematic function block diagram showing function blocks of a result output module of the apparatus for integratedly managing static analysis tools according to an exemplary embodiment of the present invention;

FIG. 9 is a schematic function block diagram showing function blocks of an analysis configuration module of the apparatus for integratedly managing static analysis tools according to an exemplary embodiment of the present invention;

FIG. 10 is a schematic function block diagram showing function blocks of an execution management module of the apparatus for integratedly managing static analysis tools according to an exemplary embodiment of the present invention;

FIG. 11 is a view illustrating a screen image of integratedly executing and managing static analysis tools provided by an execution and management interface of the apparatus for integratedly managing static analysis tools according to an exemplary embodiment of the present invention;

FIG. 12 is a view illustrating a screen image of outputting results obtained by integratedly analyzing static analysis tools provided by the result output module of the apparatus for integratedly managing static analysis tools according to an exemplary embodiment of the present invention; and

FIG. 13 is a view illustrating a screen image of outputting an integrated analysis and configuration of static analysis tools provided by the analysis configuration module of the apparatus for integratedly managing static analysis tools according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In describing the present invention, if a detailed explanation for a related known function or construction is considered to unnecessarily divert from the gist of the present invention, such explanation will be omitted but would be understood by those skilled in the art. In the drawings, in order to provide clarity, parts unrelated to the description will be omitted and the same reference numerals will be used throughout to designate the same or like components.

Unless explicitly described to the contrary, the word “comprise” and variations such as “comprises” or “comprising,” will be understood to imply the inclusion of stated elements but not the exclusion of other elements.

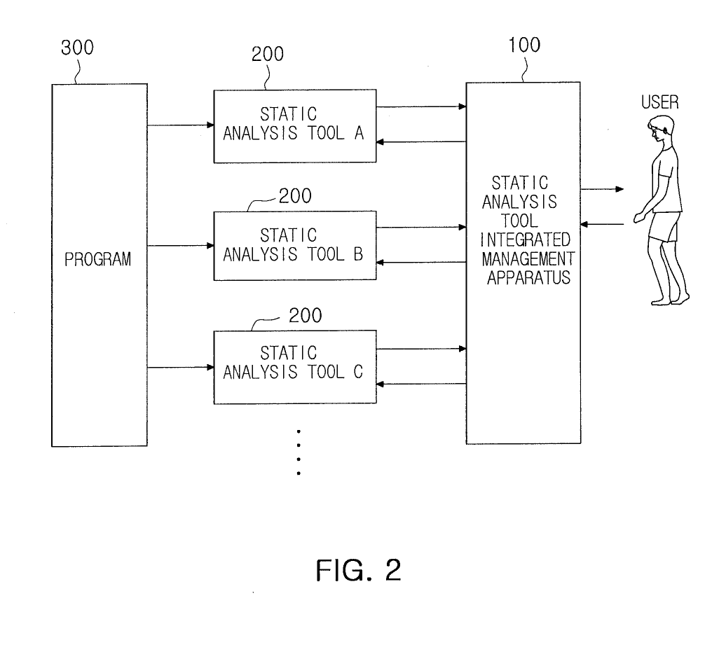

FIG. 2 is a schematic block diagram of a system for integratedly managing static analysis tools using an apparatus for integratedly managing static analysis tools according to an exemplary embodiment of the present invention.

With reference to FIG. 2, the system for integratedly managing static analysis tools according to an exemplary embodiment of the present invention may be configured to include a plurality of static analysis tools 200 and an apparatus 100 for integratedly managing static analysis tools (or ‘static analysis tool integrated management apparatus’).

A program 300, i.e., a subject or target to be analyzed, which has passed through a source code or an object code or a preprocessor, is input to the plurality of static analysis tools 200.

The plurality of static analysis tools, namely, static analysis tools A to C 200 may be conventionally used program static analysis tools. The plurality of static analysis tools 200 performs static analysis on the program 300 by using information configured by a user to determine whether or not the program 300 conforms to a verification rule.

The static analysis tool integrated management apparatus 100 may provide an integrated interface to allow the user to integratedly or collectively configure the plurality of static analysis tools 200, issue a command and perform management to allow for setting and analyzing the plurality of static analysis tools 200, put the analysis results from the plurality of static analysis tools 200 together, and output the analysis result to the user. In addition, when the user inputs the results obtained by reviewing the analysis results to the static analysis tool integrated management apparatus 100, the static analysis tool integrated management apparatus 100 delivers the inputted results to each of the plurality of static analysis tools 200.

The user can be apprised of the static analysis results through the integrated management system, and when the user configures a user analysis by additionally analyzing the analysis results, the configured value may be delivered to each of the static analysis tools 200. This information may be used when the respective static analysis tools 200 perform analyzing.

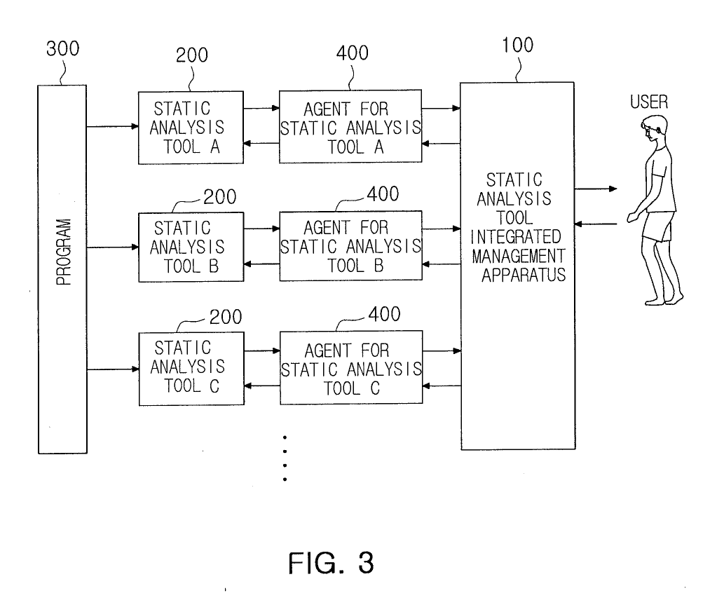

FIG. 3 is a schematic block diagram of a system for integratedly managing static analysis tools using an apparatus for integratedly managing static analysis tools according to another exemplary embodiment of the present invention.

With reference to FIG. 3, the system for integratedly managing static analysis tools according to another exemplary embodiment of the present invention may further include agents 400 for the respective static analysis tool agents. In this case, however, the static analysis tools 200 and the static analysis tool integrated management apparatus 100 according to the present exemplary embodiment may be connected by using a network, instead of the agents 400.

The respective static analysis tools may provide different interfaces. Namely, the static analysis tool A may provide a Web page as an interface, the static analysis tool B may provide a command line, and the static analysis tool C may provide an interface of an API format.

The agents 400 are provided between the static analysis tool integrated management apparatus 100 and the respective static analysis tools in order to increase connectivity with the static analysis tools and quickly cope with a change in the respective static analysis tools. For an input and output of the static analysis tool integrated management apparatus 100, the agents 400 access the static analysis tool A through a Web interface, the static analysis tool B through a command line, and the static analysis tool C through the interface of the API format. In this case, the respective static analysis tools may be installed in different systems, so a method for connecting tools and delivering information of detailed modules may not be limited to particular methods of files of a system, an API, a network, an agent system, and the like.

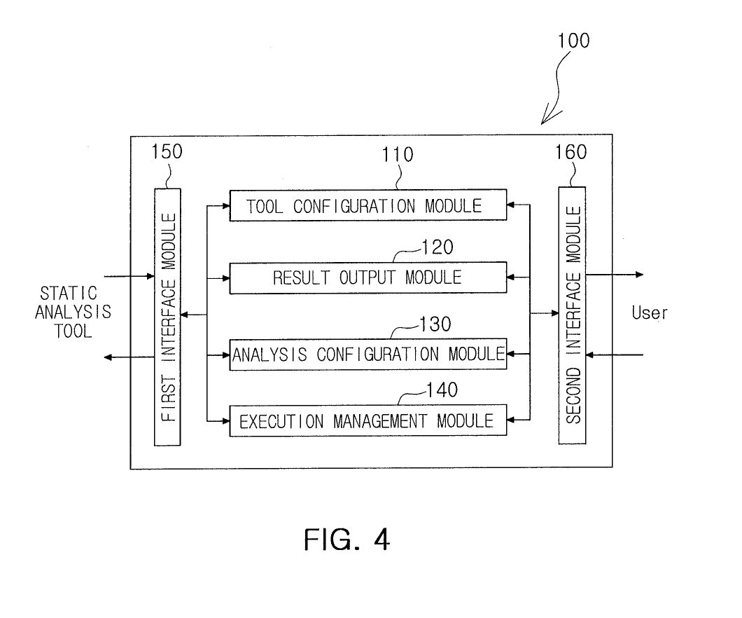

FIG. 4 is a schematic function block diagram showing function blocks of the apparatus for integratedly managing static analysis tools according to an exemplary embodiment of the present invention.

With reference to FIG. 4, the static analysis tool integrated management apparatus 100 according to the present exemplary embodiment may be configured to include a tool configuration (or setup) module 110, a result output module 120, an analysis configuration module 130, and an execution management module 140. The static analysis tool integrated management apparatus 100 may further include a first interface module 150 and a second interface module 160.

The tool configuration module 110 provides an environment in which the user can select a target program, a verification rule, and the like. Also, the tool configuration module 110 can integratedly configure the respective static analysis tools 200.

The result output module 120 integratedly outputs analysis results from the plurality of static analysis tools 200 as a file, a database, and the like. Accordingly, the user can integratedly check the analysis results from the respective static analysis tools 200.

The analysis configuration module 130 provides an environment in which it is determined whether or not the integrated analysis results outputted from the result output module 120 are an error which is to be reviewed and checked again by the user, whether or not the results are sure to be an error, whether or not the results are sure to be not an error, and the like. The information is delivered to the respective static analysis tools 200 so as to be referred to in the execution of the respective static analysis tools 200.

The execution management module 140 provides an environment in which the user can control the process of analyzing the program 300 by the respective static analysis tools 200. Through this, the user can integratedly control the analysis process of the respective static analysis tools 200.

Although not shown, the tool configuration module 110, the result output module 120, the analysis configuration module 130, and the execution management module 140 may directly connect the user and the static analysis tools 200. In this case, the respective modules 110 to 140 may include interfaces to be connected with the user and the static analysis tools 200.

The first and second interface modules 150 and 160 are modules integrating interface devices that can be included in the tool configuration module 110, the result output module 120, the analysis configuration module 130, and the execution management module 140.

The first interface module 150 connects the tool configuration module 110, the result output module 120, the analysis configuration module 130, and the execution management module 140 to the static analysis tool. Thus, the first interface module 150 provides a user with convenience in connecting the static analysis module to the static analysis tool integrated management apparatus 100.

The second interface module 160 connects the tool configuration module 110, the result output module 120, the analysis configuration module 130, and the execution management module 140 to the user to provide an integrated interface to the user.

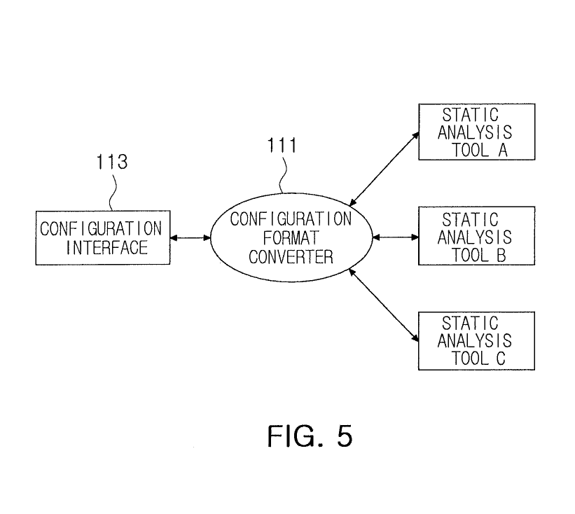

FIG. 5 is a schematic function block diagram showing function blocks of the tool configuration module of the apparatus for integratedly managing static analysis tools according to an exemplary embodiment of the present invention.

With reference to FIG. 5, the tool configuration module 110 of the present exemplary embodiment may include a configuration interface 113 and a configuration format converter 111.

The configuration interface 113 provides a configuration environment in which the user can integratedly configure static analysis tools. In general, the configuration environment may include items to be checked by the user for a configuration and an input window for inputting required variables, and the like.

The various types of configuration information eventually aim to configure static analysis tools for the purpose of checking whether or not a program has an error, so the configured matters include a great number of matters common to all the static analysis tools. Thus, a common configuration format may be proposed by adding characteristic matters of each tool to the common matters.

In addition, the configuration interface 113 may store received configuration information. In this case, the configuration information may not necessarily be stored in a file format but in various formats such as a memory, a packet, a transaction, or the like.

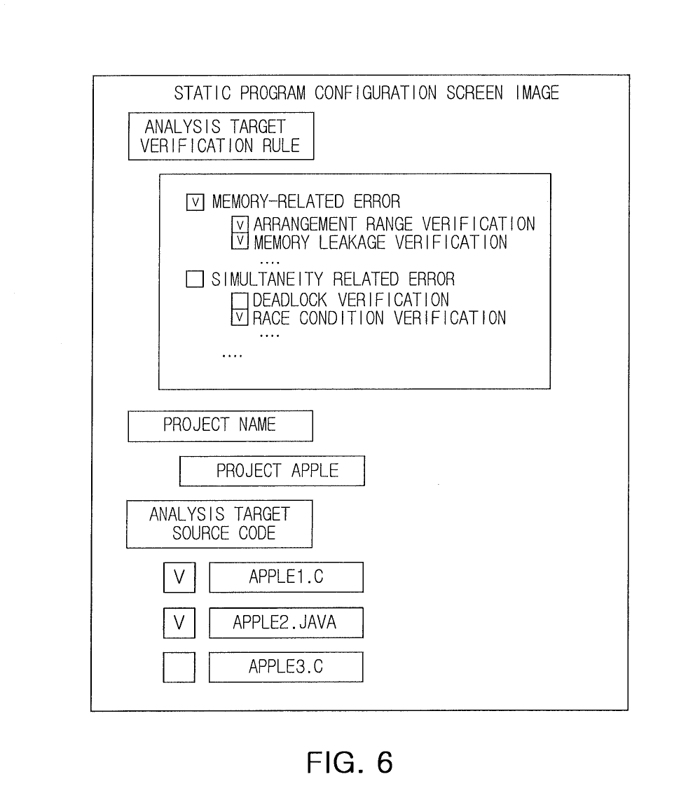

With reference to FIG. 6, the integrated configuration environment provided by the configuration interface 113 to the user necessarily includes the items ‘analysis target verification rule’ and ‘analysis target project’. The configuration interface 113 is able to arrange the analysis target verification rule hierarchically.

The configuration format converter 111 converts the configuration information inputted in the common configuration format from the configuration interface 113, such that the configuration information conforms to the configuration format of the respective static analysis tools 200, and stores the configuration content. Preferably, the configuration format converter 111 stores information regarding the configuration formats of the respective static analysis tools 200. Also, if necessary, the configuration format converter 111 may previously configure or receive the information regarding the configuration format conversion method.

The configuration format converter 111 may analyze received inspection items and select a static analysis tool 200 having an advantage over the inspection item.

For example, if the static analysis tool A 200 has an advantage over an arrangement range inspection, the configuration format converter 111 may select the static analysis tool 200A as a static analysis tool for a program analysis. The configuration format converter 111 then converts the configuration information of the common configuration format into configuration information for the static analysis tool A and transmits the converted configuration information to the static analysis tool A.

According to circumstances, the tool configuration module 110 may transmit the configuration information only to a static analysis tool having the optimum performance over the corresponding inspection.

The configuration information input to the configuration interface 113 is converted to have a common configuration format through the configuration format converter 111 and stored therein, so as to be transmitted to the respective static analysis tools 200. The respective static analysis tools 200 configure the analysis schemes of the respective static analysis tools by using an internal configuration conversion device.

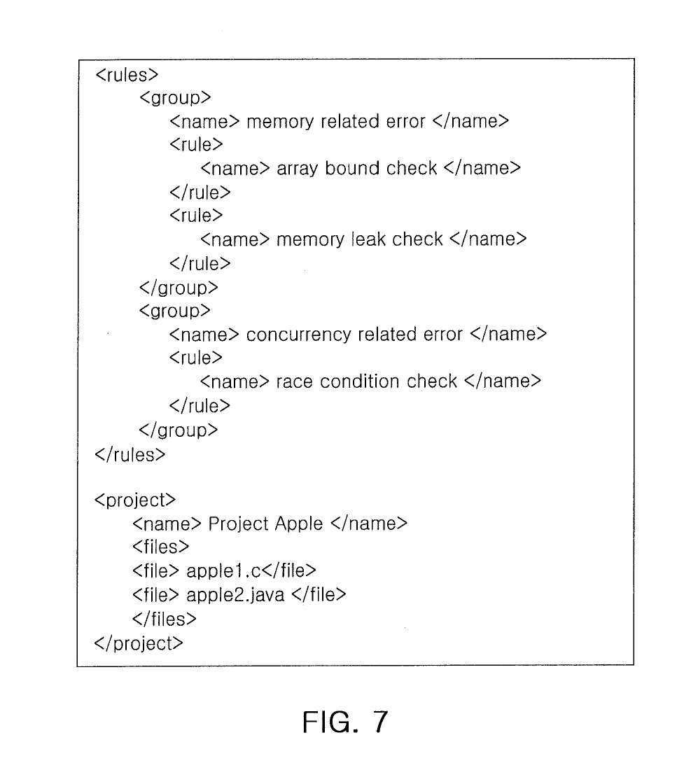

FIG. 7 is a view illustrating an example of a file stored in the common configuration format by the configuration interface of the apparatus for integratedly managing static analysis tools according to an exemplary embodiment of the present invention.

With reference to FIG. 7, the configuration interface 113 stores the configuration items, checked by the user as illustrated in FIG. 6, in the common configuration format. The file stored in the common configuration format by the configuration interface 113 employs the XML file format. However, the configuration interface 113 may store the file in a file format other than the XML file format.

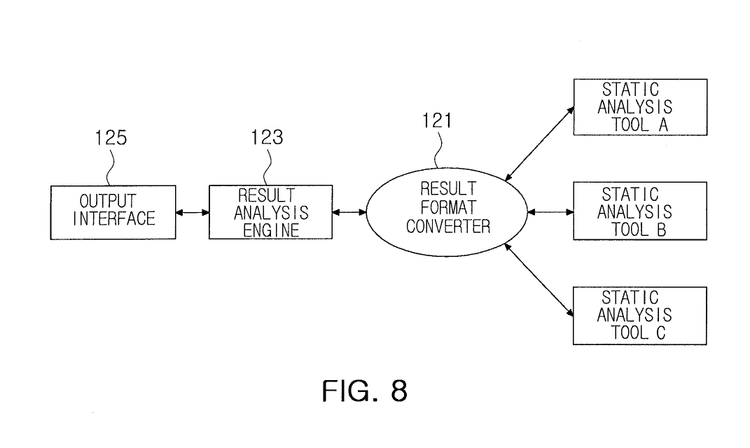

FIG. 8 is a schematic function block diagram showing function blocks of the result output module of the apparatus for integratedly managing static analysis tools according to an exemplary embodiment of the present invention.

With reference to FIG. 8, the result output module 120 according to the present exemplary embodiment may be configured to include a result format converter 121, a result analysis engine 123, and an output interface 125.

The result output module 120 according to the present exemplary embodiment receives the analysis results from the respective static analysis tools 200 and converts the received analysis results to have a common analysis result format through the result format converter 121. The analysis results transmitted from the static analysis tools 200 may include relevant information such as information regarding a path to reach an error and error information, in addition to the presence or absence of an error. The various types of result information are obtained by performing analyzing to eventually aim to check whether or not a program has an error, so the output results include a great number of common matters. Thus, a common analysis result format may be proposed by adding characteristic matters of each tool to the common matters.

The result analysis engine 123 may receive the converted results and perform an additional operation thereupon. Such an additional operation may include adjusting the order of priority of the results, performing an additional analysis, settling a common result part, and the like.

The output interface 125 outputs the converted results or the additionally operated results according to a method requested by the user. The output method may include displaying the results on a screen, outputting the results in a file format, and the like. Only results associated with the analysis items configured through the tool configuration module 110 may be output as necessary.

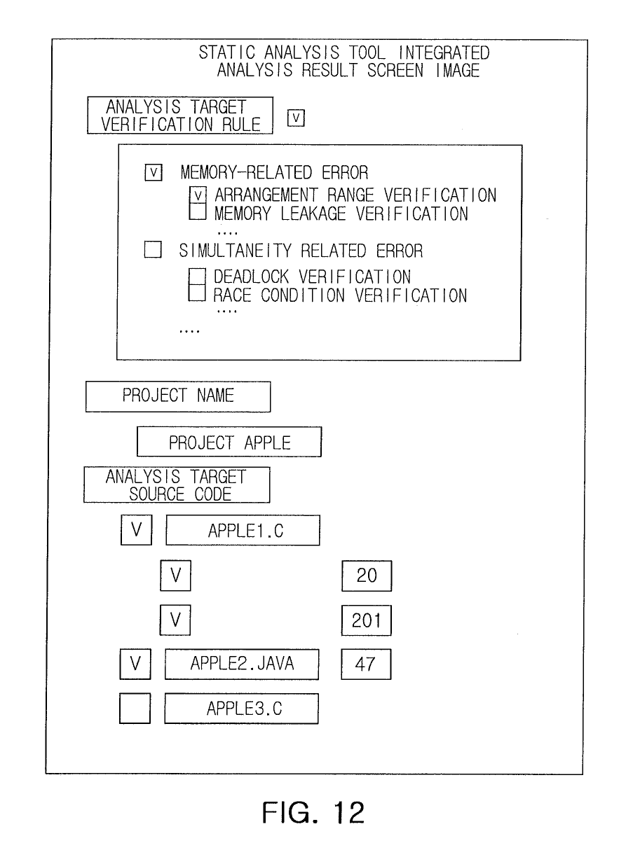

With reference to FIG. 12, an example of a screen image outputting the analysis results provided by the result output module of the static analysis tool integrated management apparatus 100 according to the present exemplary embodiment can be checked.

A ‘V’ expressed on the screen image indicates the presence of an error. For example, when there is an error in an arrangement range verification, ‘V’ is also indicated in a memory-related error, an upper group related to a verification rule, resultantly showing that it has failed to pass all the analysis target verification rules.

A source code appearing at a lower portion of the analysis result output screen image illustrated in FIG. 12 indicates parts including an error. Namely, when the arrangement range verification is selected, the file name of the source code with a corresponding error, line numbers, and the like, are displayed so as to provide a user with convenience in correcting the error. In the example illustrated in FIG. 12, it is noted that there is an error in apple1.c, wherein the 20th and 201st lines each contain an error. In addition, it is noted that there is an error in the 47th line in apple2.java.

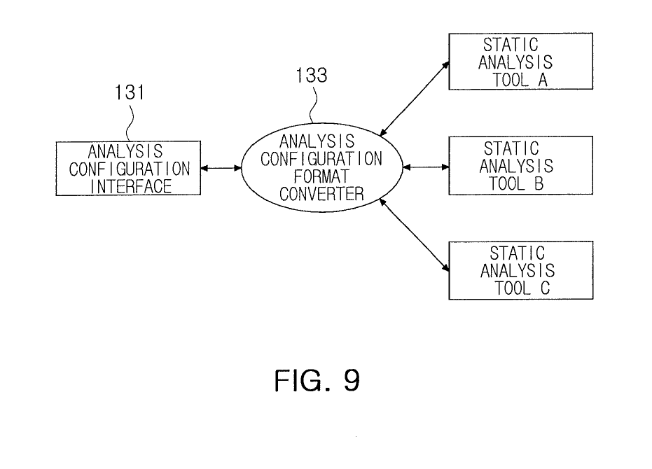

FIG. 9 is a schematic function block diagram showing function blocks of the analysis configuration module of the apparatus for integratedly managing static analysis tools according to an exemplary embodiment of the present invention.

With reference to FIG. 9, the analysis configuration module 130 according to the present exemplary embodiment may be configured to include an analysis configuration interface 131 and an analysis configuration format converter 133.

The user reviews the integrated analysis results from the plurality of static analysis tools 200 and inputs the reviewed analysis results to the static analysis tools 200 based on the information regarding whether or not an error has been checked, whether or not the error is an erroneous error, or whether or not the error has been corrected, so that the static analysis tools 200 may not perform a repeated operation. In this case, because readjustments of analysis configurations based on the analysis result review are different for each of the static analysis tools 200, the static analysis tool integrated management apparatus 100 according to the present exemplary embodiment provides an environment in which the respective static analysis tools 200 can be integratedly configured for analysis.

When the user inputs the user analysis results obtained by analyzing the results from the integrated program static analysis tools through a user analysis, configuration interface, the user analysis results are stored in a static analysis tool common user analysis configuration format. The user analysis configuration is converted by a user analysis configuration converter of each of the static analysis tools, which is then transmitted to each of the static analysis tools.

The analysis configuration interface 131 provides a configuration environment in which the user can integratedly analyze and configure the static analysis tools. In general, the configuration environment may include items to be checked by the user for an analysis configuration, an input window for inputting required variables, and the like, and items to be checked as to whether or not errors extracted from the respective analysis results are true, and the like.

The various types of analysis configuration information eventually aim to analyze and configure static analysis tools for the purpose of whether or not a program has an error and for the purpose of readjusting the configuration of static analysis tools. Thus, because the analysis configuration matters include a great number of matters common to all the static analysis tools, a common configuration format may be proposed by adding the characteristic matters of each tool to the common matters.

The analysis configuration format converter 133 converts the analysis configuration information inputted in the common analysis configuration format from the analysis configuration interface 131 according to the analysis configuration format of each of the static analysis tools 200 and stores the configuration content. Preferably, the analysis configuration format converter 133 stores information regarding the analysis configuration format of each of the static analysis tools 200 connected thereto. Also, the configuration format converter 111 may previously set or receive information regarding a configuration format conversion method.

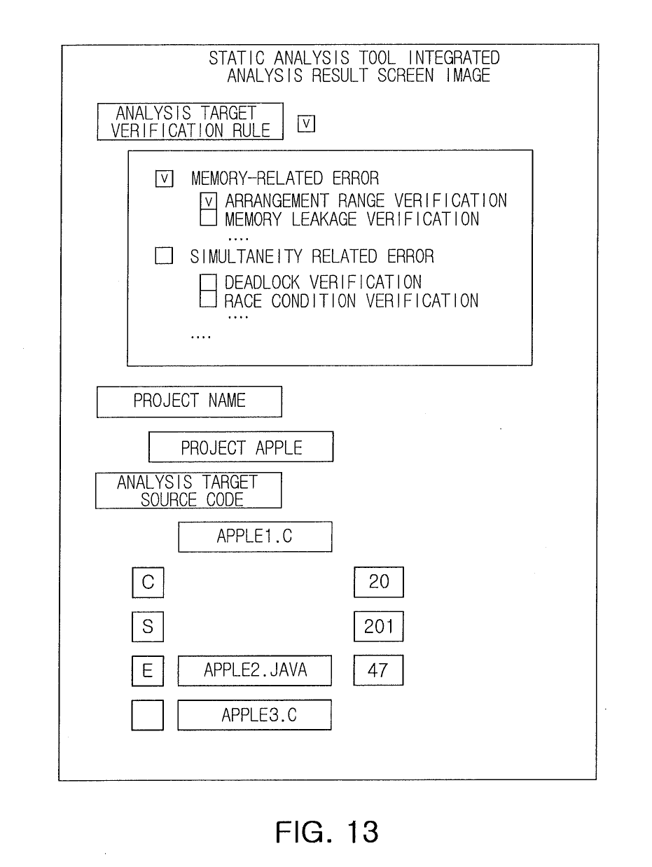

With reference to FIG. 13, an example of a screen image of an analysis configuration provided by the analysis configuration module of the static analysis tool integrated management apparatus 100 according to the present exemplary embodiment can be checked.

The user reviews the results from the analysis tools and inputs his analysis opinion. For example, among three errors discovered as arrangement range verification errors, an error found in the 20th line of apple1.c is intentionally expressed by the user, which has a problem based on a verification rule but not actually generated. The error in the 201st line indicates that it has not been analyzed by the user yet. An error in the 47th line of apple2.java indicates that it has been confirmed as an error. Through such representation, the errors may be later corrected and subjected to re-analysis.

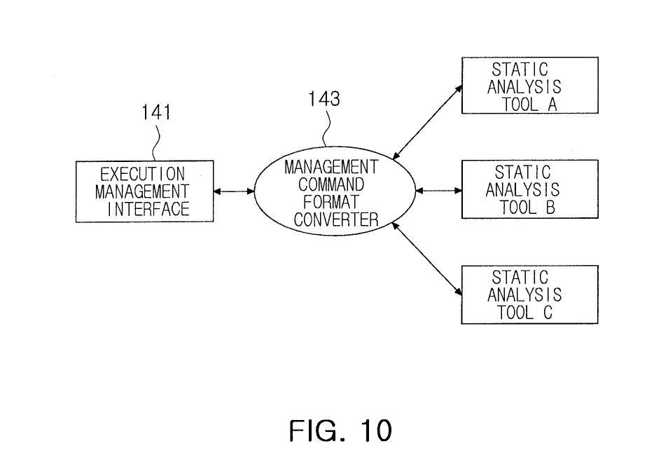

FIG. 10 is a schematic function block diagram showing function blocks of the execution management module of the apparatus for integratedly managing static analysis tools according to an exemplary embodiment of the present invention.

The execution management module 140 integratedly arbitrates execution of the respective static analysis tools 200 overall.

The user may deliver an overall execution management command to the respective static analysis tools 200 through the execution management module 140, and check an executed state of the respective static analysis tools 200 through the execution management module 140. Thus, the execution management module 140 allows the user to integratedly and effectively manage the entirety of the static analysis tools 200.

The functions performed by the execution management module 140 may include management to determine whether to execute the entire static analysis tools, management to configure the respective static analysis tools 200, and management of the verification rules of the static analysis tools.

The function of managing as to whether to execute the static analysis tools 200 refers to a function enabling the static analysis tools 200 to start verification and terminate the verification as configured by the tool configuration module 110. Namely, when the execution management module 140 transmits a start command to the static analysis tool 200, the corresponding static analysis tool 200 starts analyzing by using a configured verification rule, the source code, and the like. Also, when the execution management module 140 transmits a termination command to the static analysis tool 200, the corresponding static analysis tool 200 terminates the analyzing.

Because the execution management module 140 manages the analysis execution and termination of the respective static analysis tools 200, the respective static analysis tools 200 may be distributed to be disposed in different systems. The efficiency of verification of the static analysis tools 200 can be increased by distributedly disposing the static analysis tools 200. In addition, when the plurality of the same static analysis tools 200 are distributedly installed, analysis can be processed in a parallel manner, and thus, the system for integratedly managing the static analysis tools can be designed such that the load of the individual static analysis tools 200 is reduced.

The function of managing the configuration of the respective static analysis tools 200 themselves provides an environment allowing the user to set an IP address of the system in which the individual static analysis tools 200 are installed to operate, as well as an account name, a password, the location or file name of each tool, and the like.

The function of managing the verification rules of the static analysis tools is a function of allowing a particular static analysis tool to perform analyzing according to a verification rule. The static analysis tools 200 are different in their analyzing methods, so a particular static analysis tool 200 may exert good performance for a particular verification rule. Thus, each static analysis tool advantageous for each verification rule to perform analyzing, whereby the system for integratedly managing the static analysis tools can be effectively operated.

With reference to FIG. 10, the execution management module 140 for implementing the function according to the present exemplary embodiment may be configured to include an execution management interface 141 and a management command format converter 143.

The execution management interface 141 receives matters related to an execution management of the respective static analysis tools 200 from the user, and provides an execution management situation for user's monitoring.

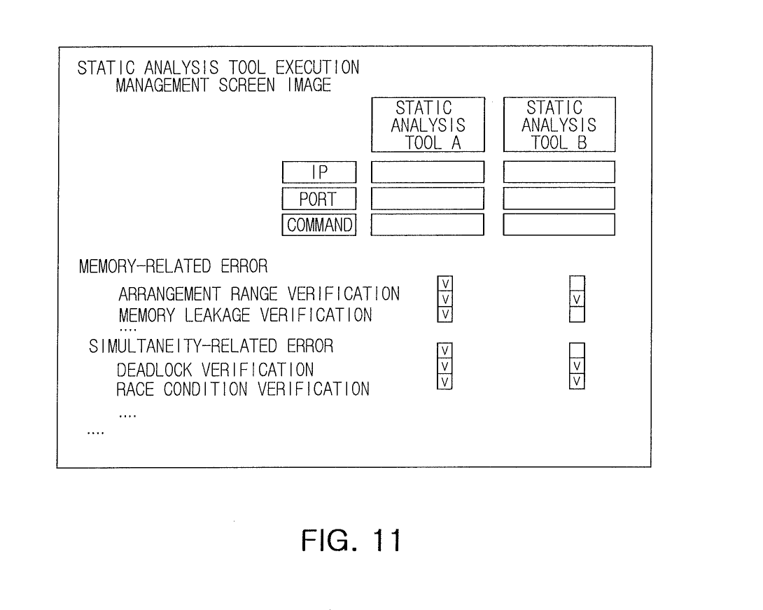

With reference to FIG. 11, the execution management interface 141 may provide a static analysis tool integrated execution management screen image for receiving an execution management of the respective static analysis tools 200 and relevant matters, to the user. It is noted that input parts for managing configuration of the respective static analysis tools 200 themselves are included.

The management command format converter 143 converts an integrated execution management command received through the execution management interface 141 to have an execution management command format required by the respective static analysis tools 200, and transmits the same to the respective static analysis tools 200. In addition, the management command format converter 143 can manage the verification rules of the static analysis tools 200 by analyzing the execution management command. Preferably, the management command format converter 143 stores information regarding the execution management command formats of the respective static analysis tools 200. Also, the management command format converter 143 may previously configure or receive information regarding an execution management command format conversion method as necessary.

As set forth above, in the apparatus and system for integratedly managing static analysis tools according to exemplary embodiments of the invention, the user can integratedly or collectively use a plurality of static analysis tools through an integrated environment, rather than individually setting and managing the respective static analysis tools and analyzing the results. Thus, accuracy and utilization of the static analysis tools can be improved, and because the static analysis tools are used in a distributed environment, the performance of the static analysis tools can be also enhanced.

While the present invention has been shown and described in connection with the exemplary embodiments, it will be apparent to those skilled in the art that modifications and variations can be made without departing from the spirit and scope of the invention as defined by the appended claims.

What is claimed is:

1. An apparatus for integratedly managing static analysis tools, the apparatus comprising:
a tool configuration module receiving initial configuration information in an integrated configuration format for an analysis of static analysis tools from a user, converting the initial configuration information in the integrated configuration format into initial configuration information in an initial configuration format of the static analysis tools, and transmitting the same;
a result output module receiving analysis results from the static analysis tools, converting the received analysis results into a common analysis result format, and outputting the same;
an analysis configuration module receiving analysis configuration information from the user, converting the received analysis configuration information into analysis configuration information in an analysis configuration format of the static analysis tools, and transmitting the same; and
an execution management module performing one or more of functions such as management of the analysis performing of the static analysis tools, management of the configuration of the static analysis tools themselves, and management of the verification rules of the static analysis tools.

2. The apparatus of claim 1, wherein the tool configuration module comprises:
a configuration interface providing a configuration environment allowing the user to integratedly configure the static analysis tools; and
a configuration format converter receiving the initial configuration information in the integrated configuration format from the configuration interface, converting the received initial configuration information in the integrated configuration format into the initial configuration information in the initial configuration format of the static analysis tools, and transmitting the same to a pertinent static analysis tool.

3. The apparatus of claim 2, wherein the configuration interface stores the initial configuration information in the integrated configuration format, and the configuration format converter stores information regarding a configuration format suitable for each of the static analysis tools.

4. The apparatus of claim 1, wherein the result output module comprises:
a result format converter converting the analysis results such that the analysis results has the common analysis result format; and
an output interface outputting the converted analysis results according to a user request or in a pre-set manner.

5. The apparatus of claim 4, wherein the result output module further comprises a result analysis engine receiving the converted analysis results from the result format converter and performing one or more of adjusting the order of priority of the analysis results, additional analyzing based on the analysis results, and sorting out repeated analysis results among the analysis results.

6. The apparatus of claim 1, wherein the analysis configuration module comprises:
an analysis configuration interface providing an analysis configuration environment allowing the user to integratedly analyze and configure the static analysis tools; and
an analysis configuration format converter receiving the analysis configuration information from the analysis configuration interface, converting the analysis configuration information such that it has an analysis configure format suitable for the static analysis tools, and transmitting the same to a pertinent static analysis tool.

7. The apparatus of claim 6, wherein the analysis configuration interface stores the analysis configuration information in an analysis configuration format, and the analysis configuration format converter stores information regarding an analysis configuration format suitable for the static analysis tools.

8. The apparatus of claim 1, wherein the execution management module comprises:
an execution management interface receiving an execution management command in an integrated execution command format related to an execution management of the static analysis tools from the user and providing an execution management situation to the user for user's monitoring; and
a management command format converter receiving the execution management command in the integrated execution command format from the execution management interface, converting the execution management command such that it has an execution command format of the static analysis tools, and transmitting the same.

9. The apparatus of claim 8, wherein the management command format converter analyzes the execution management command to select a static analysis tool to perform analysis on each of verification regulations.

10. A system for integratedly managing static analysis tools, the system comprising:
a plurality of static analysis tools statically analyzing an analysis target program; and
an apparatus integratedly managing static analysis tools and including a tool configuration module receiving initial configuration information in an integrated configuration format for an analysis of static analysis tools from a user, converting the initial configuration information in the integrated configuration format into initial configuration information in the initial configuration format of the static analysis tools, and transmitting the same, a result output module receiving analysis results from the static analysis tools, converting the received analysis results into a common analysis result format, and outputting the same, an analysis configuration module receiving analysis configuration information from the user, converting the received analysis configuration information into analysis configuration information in an analysis configuration format of the static analysis tools, and transmitting the same, and an execution management module performing one or more of functions such as management of the analysis performing of the static analysis tools, management of the configuration of the static analysis tools themselves, and management of the verification rules of the static analysis tools.

11. The system of claim 10, wherein the plurality of static analysis tools are distributed to be installed in one or more network equipment.

12. The system of claim 10, further comprising a static analysis tool agent or a network connection device installed between the plurality of static analysis tools and the apparatus for integratedly managing static analysis tools.

13. The system of claim 11, wherein the execution management module distributes analysis matters or regulations to the plurality of static analysis tools to allow the plurality of static analysis tools which are distributedly installed to process analyzing in parallel.

14. The system of claim 10, wherein the tool configuration module comprises:
a configuration interface providing a configuration environment allowing the user to integratedly configure the static analysis tools; and
a configuration format converter receiving the initial configuration information in the integrated configuration format from the configuration interface, converting the received initial configuration information in the integrated configuration format into the initial configuration information in the initial configuration format of the static analysis tools, and transmitting the same to a pertinent static analysis tool.

15. The system of claim 10, wherein the result output module comprises:
a result format converter converting the analysis results such that the analysis results has the common analysis result format; and
an output interface outputting the converted analysis results according to a user request or in a pre-set manner.

16. The system of claim 10, wherein the analysis configuration module comprises:
an analysis configuration interface providing an analysis configuration environment allowing the user to integratedly analyze and configure the static analysis tools; and
an analysis configuration format converter receiving the analysis configuration information from the analysis configuration interface, converting the analysis configuration information such that it has an analysis configure format suitable for the static analysis tools, and transmitting the same to a pertinent static analysis tool.

17. The system of claim 10, wherein the execution management module comprises:
an execution management interface receiving an execution management command in an integrated execution command format related to an execution management of the static analysis tools from the user and monitoring the execution management situation to the user; and
a management command format converter receiving the execution management command in the integrated execution command format from the execution management interface, converting the execution management command such that it has an execution command format of the static analysis tools, and transmitting the same.
